(19) United States
(12) Patent Application Publication
(10) Pub. No.: US 2012/0089567 A1
(43) Pub. Date: Apr. 12, 2012

(54) Storage device, data replication method, and storage system

(75) Inventors: Hideaki Takahashi, Yokohama (JP); Mana Tanaka, Yokohama (JP); Hideyuki Tanaka, Kawasaki (JP)

(73) Assignee: FUJITSU LIMITED, Kawasaki (JP)

(21) Appl. No.: 13/200,594

(22) Filed: Sep. 27, 2011

(30) Foreign Application Priority Data
Oct. 6, 2010 (JP) 2010-226892

(51) Int. Cl. G06F 17/30; G06F 15/16

(52) U.S. Cl. 707/634; 707/E17.005

(57) ABSTRACT

A storage device includes a accepting unit that accepts a replication request that concerns a replication storage area for target data and that is from a requesting server that is among a plurality of servers; a first determining unit that, if a replication request is accepted, determines whether an identifier of the requesting server is included in a first table that stores identifiers of the servers that satisfy a first condition; a second determining unit that, if a replication request is accepted, determines whether the identifier of the requesting server is included in a second table that stores identifiers of the servers that satisfy a second condition; and an executing unit that executes a replication process of replicating the target data to the replication storage area, if the first or the second determining unit determines that the identifier is included.

### CROSS REFERENCE TO RELATED APPLICATIONS

This application is based upon and claims the benefit of priority of the prior Japanese Patent Application No. 2010-226892, filed on Oct. 6, 2010, the entire contents of which are incorporated herein by reference.

### FIELD

The embodiment discussed herein is related to data replication between physically separate devices.

### BACKGROUND

Conventionally, in storage area network (SAN) environments, technology exists in which a storage apparatus autonomously replicates data. Further, in SAN environments, technology exists in which servers and storage devices are correlated and data in the storage device is exclusively handled (see, for example, Japanese Laid-Open Patent Publication Nos. 2003-242039, 2005-276160, and 2006-146801).

However, with the technologies above, even if access to the data in the storage device from servers is restricted, a problem arises in that the autonomous replication function of the storage device is used for unauthorized replication of the data.

### SUMMARY

According to an aspect of an embodiment, a storage device includes an accepting unit that accepts a replication request that concerns a replication storage area for target data and that is from a requesting server that is among a plurality of servers; a first determining unit that, if a replication request is accepted by the accepting unit, determines whether an identifier of the requesting server is included in a first table that stores identifiers of the servers that satisfy a first condition; a second determining unit that, if a replication request is accepted by the accepting unit, determines whether the identifier of the requesting server is included in a second table that stores identifiers of the servers that satisfy a second condition; and an executing unit that executes a replication process of replicating the target data to the replication storage area, if the first or the second determining unit determines that the identifier of the requesting server is included.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic of an example of a data replication scheme according to the present embodiment.

FIG. 2 is a block diagram of an example of a hardware configuration of a computer according to the present embodiment.

FIG. 3 is a system configuration schematic of an example of a storage system according to the present embodiment.

FIG. 4 is a schematic of an example of the contents of a server/LUN correspondence table.

FIG. 5 is a schematic of an example of the contents of a server information table.

FIG. 6 is a schematic of the contents of a proprietary information table.

FIG. 7 is a schematic of an example of the contents of an authorization information table.

FIG. 8 is a block diagram of a function configuration of a storage device.

FIG. 9 is a schematic of an example of a replication request.

FIG. 10 is a schematic of an example of LUN data configuration.

FIG. 11 is a schematic of an example of LUN management information transmission.

FIG. 12 is a schematic of an example of a data authorization request.

FIG. 13 is a schematic of an example of a data authorization response.

FIG. 14 is a schematic of an example of a LUN authorization request.

FIG. 15 is a schematic of an example of a LUN authorization response.

FIG. 16 is a flowchart of a data replication process by the storage device according to the present embodiment.

FIG. 17 is a schematic of a first example of application of the data replication scheme.

FIG. 18 is a schematic of a second example of application of the data replication scheme.

FIG. 19 is a schematic of a third example of application of the data replication scheme.

### DESCRIPTION OF EMBODIMENTS

Preferred embodiments of the present invention will be explained with reference to the accompanying drawings.

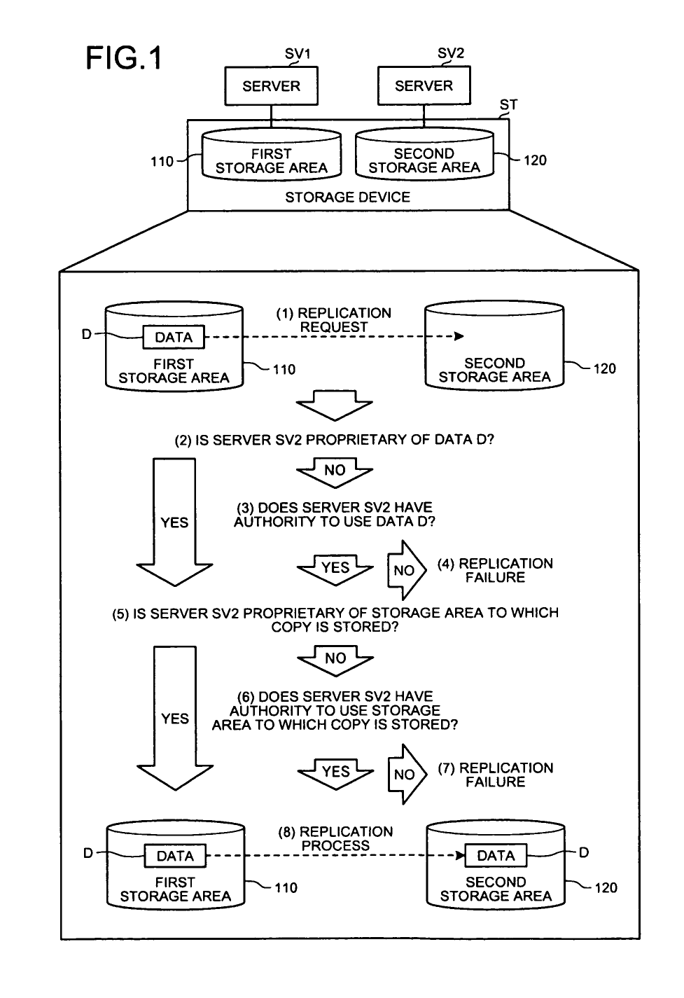

FIG. 1 is a schematic of an example of a data replication scheme according to the present embodiment. In FIG. 1, a server SV1 may access a first storage area 110 in a storage device ST. Further, a server SV2 may access a second storage area 120 in the storage device ST.

In the description of the data replication scheme according to the present embodiment, an example will be described where the storage device ST accepts from the server SV2, a replication request requesting replication of data D in the first storage area 110 to the second storage area 120.

(1) The storage device ST accepts from the server SV2, a replication request requesting replication of data D in the first storage area 110 to the second storage area 120.

(2) The storage device ST determines whether the server SV2 (the requesting server) is the proprietary of data D. Here, a server that is the proprietary of data D is a server that is operable to access data D. In this example, the server that is the proprietary of data D is the server SV1, which is operable to access the first storage area 110.

At (2), if the server SV2 is the proprietary of data D, the storage device ST proceeds to (5). On the other hand, if the server SV2 is not the proprietary of data D, the storage device ST proceeds to (3). In this example, the server SV2 is not the proprietary of data D and therefore, the storage device ST proceeds to (3).

(3) The storage device ST determines whether the server SV2 (requesting server) has authority to use data D. Here, a server having authority to use data D is a server that has authorization to replicate data D from an arbitrary storage area. In this example, it is assumed that the server SV2 has authority to use data D.

At (3), if the server SV2 has authority to use data D, the storage device ST proceeds to (5). On the other hand, if the server SV2 does not have authority to use data D, (4) the storage device ST notifies the server SV2 that replication failed. In this example, the server SV2 has authority to use data D and therefore, the storage device ST proceeds to (5).

(5) The storage device ST determines whether the server SV2 (requesting server) is the proprietary of the storage area to which data D is replicated. Here, the server that is the proprietary of the storage area to which data D is replicated is a server that is operable to access the storage area to which data D is to be replicated. In this example, a server that is the proprietary of the storage area to which data D is replicated is the server SV2, which is operable to access the second storage area 120 that is the storage area to which data D is replicated.

At (5), if the server SV2 is the proprietary of the storage area to which data D is replicated, the storage device ST proceeds to (8). On the other hand, if the server SV2 is not the proprietary of the storage area to which data D is replicated, the storage device ST proceeds to (6). In this example, the server SV2 is the proprietary of the storage area to which data D is replicated and therefore, the storage device ST proceeds to (8).

(6) The storage device ST determines whether the server SV2 (requesting server) has authority to use the storage area to which data D is to be replicated. Here, a server having authority to use the storage area to which data D is to be replicated is a server that has authorization to replicate arbitrary data to the storage area.

At (6), if the server SV2 has authority to use the storage area to which data D is to be replicated, the storage device ST proceeds to (8). On the other hand, if the server SV2 does not have authority to use the storage area to which data D is to be replicated, (7) the storage device ST notifies the server SV2 that the replication failed.

(8) The storage device ST executes a replication process of replicating data D to the second storage area 120, which is the storage area to which data D is to be replicated. For example, the storage device ST reads data D from the first storage area 110 and writes data D to the second storage area 120.

In this manner, in the data replication scheme, if the server SV2 (requesting server) is the proprietary of or has authority to use data D, which is the replication target, and is the proprietary of or has authority to use the second storage area 120, which is the storage area to which data D is to be replicated, the replication process of data D is executed with respect to the second storage area 120. In other words, even if the replication request is for replication to the storage area 120 that is accessible by the server SV2 (requesting server), if the server SV2 is not the proprietary of or does not have authority to use data D, the replication process is not performed.

Further, even if the replication request is for data D, which is accessible by the server SV2 (requesting server), if the server SV2 is not the proprietary of or does not have authority to use the second storage area 120 to which data D is to be replicated, the replication process is not performed. Consequently, according to the data replication scheme, use of the autonomous data replication function of the storage device ST for unauthorized data replication may be prevented.

Next, a hardware configuration of a computer (e.g., servers SV1, SV2 and storage device ST depicted in FIG. 1) according to the present embodiment will be described.

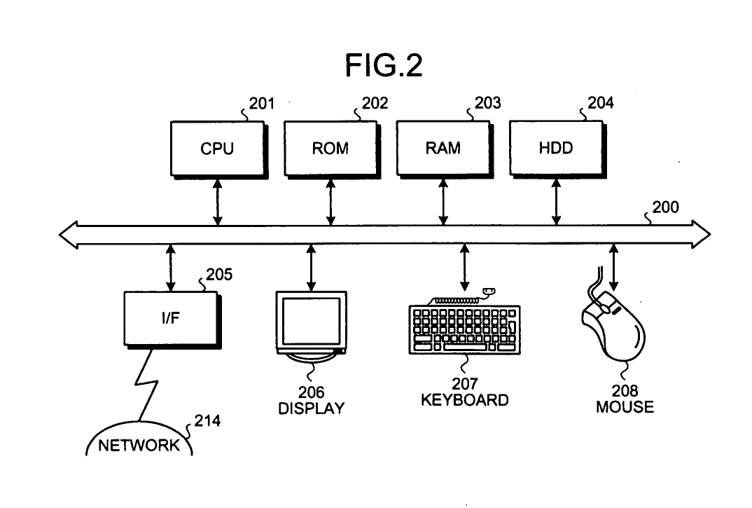

FIG. 2 is a block diagram of an example of a hardware configuration of the computer according to the present embodiment. In FIG. 2, the computer includes a central processing unit (CPU) 201, read-only memory (ROM) 202, random access memory (RAM) 203, a hard disk drive (HDD) 204, an interface (I/F) 205, a display 206, a keyboard 207, and a mouse 208, respectively connected by a bus 200.

The CPU 201 governs overall control of the design support apparatus. The ROM 202 stores therein programs such as a boot program. The RAM 203 is used as a work area of the CPU 201. The HHD 204 is a recording device that under the control of the CPU 201, rapidly rotates a circular disk (hard disk) to which a magnetic substance is applied, whereby a magnetic head reads and writes data. The I/F 205 is connected to a network 214 such as a local area network (LAN), a wide area network (WAN), and the Internet through a communication line and is connected to other apparatuses through the network 214. The I/F 205 administers an internal interface with the network 214 and controls the input/output of data from/to external apparatuses. For example, a modem or a LAN adaptor may be employed as the I/F 205.

The display 206 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 206.

The keyboard 207 includes, for example, keys for inputting letters, numerals, and various instructions and performs the input of data. Alternatively, a touch-panel-type input pad or numeric keypad, etc. may be adopted. The mouse 208 is used to move the cursor, select a region, or move and change the size of windows. A track ball or a joy stick may be adopted provided each respectively has a function similar to a pointing device.

Among the components 201 to 208 above, a portion thereof such as the display 206, the keyboard 207, the mouse 208, etc. may be omitted from the computer.

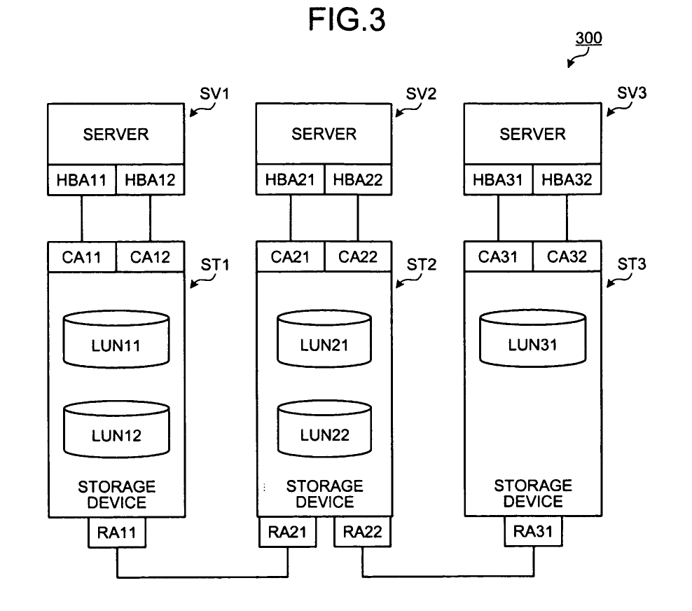

FIG. 3 is a system configuration schematic of an example of a storage system according to the present embodiment. In FIG. 3, the storage system 300 includes servers SV1 to SV3 and storage devices ST1 to ST3.

The servers SV1 to SV3 are computers having a function of operating the storage devices ST1 to ST3. Further, the servers SV1 to SV3 have a function of accessing storage areas of the storage devices ST1 to ST3 to read and write data.

The storage devices ST1 to ST3 are computers that have storage areas storing data and that control access to the storage areas. Further, the storage devices ST1 to ST3 have a function of autonomously replicating data between physically separate devices such as the storage devices ST1 to ST3.

In FIG. 3, logical unit numbers (LUN) 11, LUN 12, LUN 21, LUN 22, LUN 31 are logical volumes assigned to the storage areas of the storage devices ST1 to ST3. A logical volume is a unit for managing the storage areas of the storage devices ST1 to ST3. For example, an entire hard disk may be regarded as 1 logical volume; a partition (portion) of the hard disk may be regarded as 1 logical volume, etc. Furthermore, a combination of multiple hard disks may be regarded as 1 logical volume.

Here, a multipath configuration is between the servers SV1 to SV3 and the storage devices ST1 to ST3. For example, a path between a host bus adapter (HBA) 11 of the server SV1 and a channel adaptor (CA) 11 of the storage device ST1 is defined; and a path between an HBA 12 of the server SV1 and a CA 12 of the storage device ST1 is defined.

A path between an HBA 21 of the server SV2 and a CA 21 of the storage device ST2 is defined; and a path between an HBA 22 of the server SV2 and a CA 22 of the storage device ST2 is defined. A path between an HBA 31 of the server SV3 and a CA 31 of the storage device ST3 is defined; and a path between a HBA 32 of the server SV3 and a CA 32 of the storage device ST3 is defined.

Further, each of the storage devices ST1 to ST3 include a remote adapter (RA) for data replication between physically separate devices. For example, an RA 11 of the storage device ST1 and an RA 21 of the storage device ST2 are connected; and an RA 22 of the storage device ST2 and an R31 of the storage device ST3 are connected.

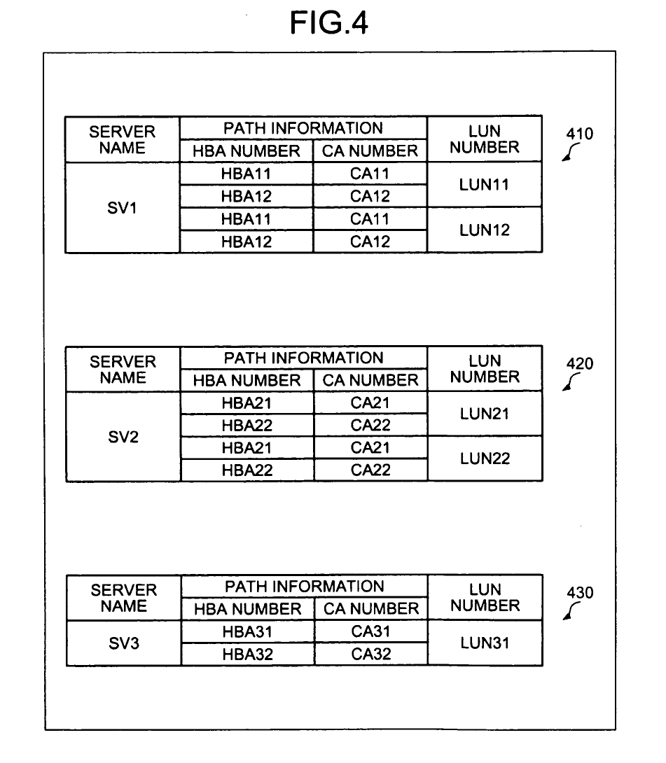

Next, using FIGS. 4 to 7, the contents of various types of tables used by the storage devices ST1 to ST3 will be described. The various types of tables depicted in FIGS. 4 to 7 are, for example, implemented by a recording device, such as the RAM 203 and the HDD 204 depicted in FIG. 2.

FIG. 4 is a schematic of one example of the contents of a server/LUN correspondence table. In FIG. 4, a server/LUN correspondence table 410 is a table used by the storage device ST1. Further, a server/LUN correspondence table 420 is a table used by the storage device ST2 and a server/LUN correspondence table 430 is a table used by the storage device ST3.

Each of the server/LUN correspondence tables 410, 420, and 430 have a server name field, a path information field, and a LUN number field. By entering information into the fields, information for identifying the servers SV1 to SV3 that are operable to access the LUN in the storage devices ST1 to ST3 is stored.

Here, a server name is a logical server identifier recognized by a user of the servers SV1 to SV3. In the description, these server names are correlated with logical server identifiers for identification of the servers SV1 to SV3 by the storage devices ST1 to ST3, and the storage devices ST1 to ST3 recognize the servers SV1 to SV3 by the server names.

Path information is information for identifying paths defined between the servers SV1 to SV3 and the storage devices ST1 to ST3. In this example, HBA numbers and CA numbers defining the paths are set. A LUN number is the identifier of a LUN in the storage devices ST1 to ST3.

For example, through the path defined between the HBA 11 of the server SV1 and the CA 11 of the storage device ST1, the server/LUN correspondence table 410 indicates that the server SV1 may access the LUN 11. Further, through the path defined between the HBA 12 of the server SV1 and the CA 12 of the storage device ST1, the server/LUN correspondence table 410 indicates that the server SV1 may access the LUN 11.

Through the path defined between the HBA 11 of the server SV1 and the CA 11 of the storage device ST1, the server/LUN correspondence table 410 indicates that the server SV1 may access the LUN 12. Through the path defined between the HBA 12 of the server SV1 and the CA 12 of the storage device ST1, the server/LUN correspondence table 410 indicates that the server SV1 may access the LUN 12.

Through the path defined between the HBA 21 of the server SV2 and the CA 21 of the storage device ST2, the server/LUN correspondence table 420 indicates that the server SV2 may access the LUN 21. Through the path defined between the HBA 22 of the server SV2 and the CA 22 of the storage device ST2, the server/LUN correspondence table 420 indicates that the server SV2 may access the LUN 21.

Through the path defined between the HBA 21 of the server SV2 and the CA 21 of the storage device ST2, the server/LUN correspondence table 420 indicates that the server SV2 may access the LUN 22; and through the path defined between the HBA 22 of the server SV2 and the CA 22 of the storage device ST2, the server/LUN correspondence table 420 indicates that the server SV2 may access the LUN 22.

Through the path defined between the HBA 31 of the server SV3 and the CA 31 of the storage device ST3m the server/LUN correspondence table 430 indicates that the server SV3 may access the LUN 31. Further, through the path defined between the HBA 32 of the server SV3 and the CA 32 of the storage device ST3, the server/LUN correspondence table 430 indicates that the server SV3 may access the LUN 31.

The storage devices ST1 to ST3, by referring to the server/LUN correspondence tables 410, 420, and 430, may identify the servers SV1 to SV3 that may access the LUNs in the storage devices ST1 to ST3. The server/LUN correspondence tables 410, 420, and 430, for example, are created in the storage devices ST1 to ST3 when the servers SV1 to SV3 and the storage devices ST1 to ST3 are connected.

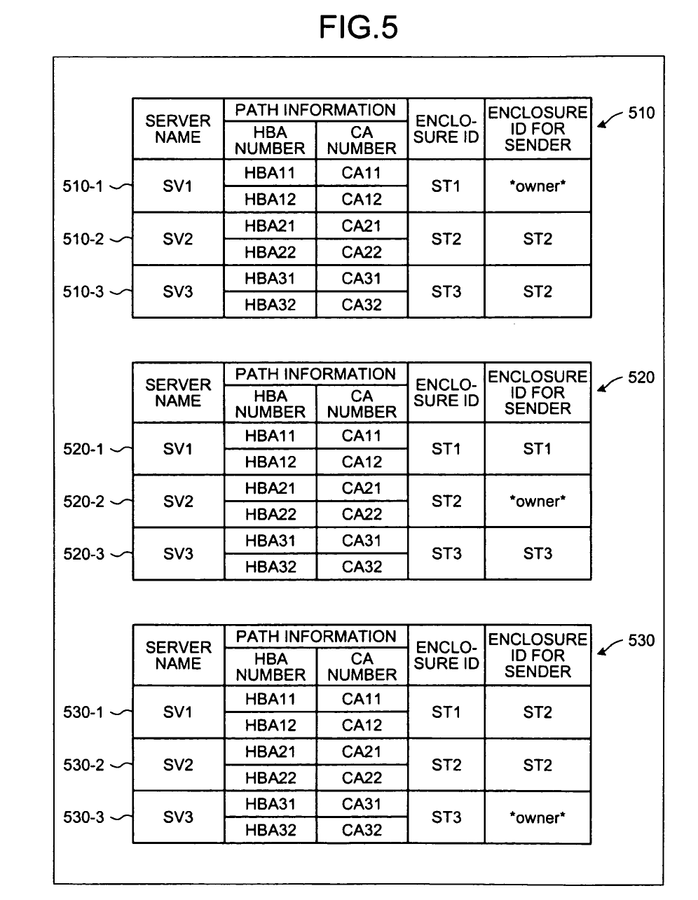

FIG. 5 is a schematic of an example of the contents of a server information table. In FIG. 5, a server information table 510 is a table used by the storage device ST1, a server information table 520 is a table used by the storage device ST2, and a server information table 530 is a table used by the storage device ST3.

Each of the server information tables 510, 520, and 530 have a server name field, a path information field, a enclosure ID field, and a enclosure ID for sender field. By entering information in the fields, server information is stored as records. For example, the server information table 510 stores server information records 510-1 to 510-3; the server information table 520 stores server information records 520-1 to 520-3; and the server information table 530 stores server information records 530-1 to 530-3.

Here, a server name is an identifier of the servers SV1 to SV3. Path information is information for identifying paths defined between the servers SV1 to SV3 and the storage devices ST1 to ST3. In this example, HBA numbers and CA numbers defining the paths are set. A enclosure ID is an identifier of physically separate devices, the storage devices ST1 to ST3. An enclosure ID for sender is information indicating the storage device that is the transfer source of the server information. “*owner*” in the enclosure ID for sender field of a server information record of a given storage device indicates that the server information in the record was created by the given server.

Here, taking the server information table 510 as an example, from the server information record 510-1, the server SV1, which is directly connected to the storage device ST1, may be identified through the paths identified by the path information. Furthermore, from the enclosure ID for sender field of the server information record 510-1, it is known that the server information record 510-1 was created by the server SV1.

From the server information record 510-2, the server SV2, which is directly connected to the storage device ST2, may be identified through the paths identified by the path information. From the enclosure ID for sender field of the server information record 510-2, it is known that the transfer source of the server information record 510-2 is the storage device ST2.

From the server information record 510-3, the server SV3, which is directly connected to the storage device ST3, may be identified through the paths identified by the path information. From the enclosure ID for sender field of the server information record 510-3, it is known that the transfer source of the server information record 510-3 is the storage device ST2.

The storage devices ST1 to ST3, for example, when connecting to a server, respectively create server information and record the information to the server information tables 510, 520, and 530. Further, the storage devices ST1 to ST3 each transmit the server information created therein, to other directly connected storage devices and further transfer received server information to other storage devices. Consequently, in the storage devices ST1 to ST3, the server information of the servers SV1 to SV3 may be shared.

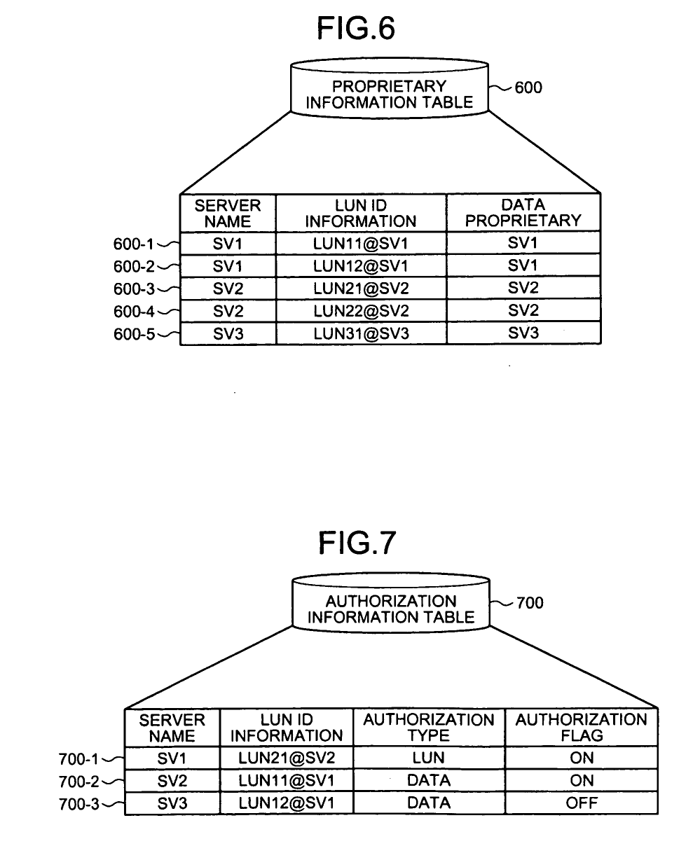

FIG. 6 is a schematic of the contents of a proprietary information table. In FIG. 6, a proprietary information table 600 has a server name field, a LUN identification (ID) information field, and a data proprietary field. By entering information in the fields, the proprietary information is stored as proprietary information records 600-1 to 600-5.

Here, a server name is an identifier of the servers SV1 to SV3. LUN ID information is an identifier of a LUN for which the server is the proprietary. In this example, LUN ID information is expressed as a combination of a LUN number and a server name. A data proprietary is an identifier of a server that is the proprietary of data stored at the LUN identified by the LUN ID information.

From the proprietary information record 600-1, it is known that the server SV1 is the proprietary of the LUN 11 and of data stored at the LUN 11. From the proprietary information record 600-2, it is known that the server SV1 is the proprietary of the LUN 12 and of data stored at the LUN 12.

From the proprietary information record 600-3, it is known that the server SV2 is the proprietary of the LUN 21 and of data stored at the LUN 21. From the proprietary information record 600-4, it is known that the server SV2 is the proprietary of the LUN 22 and of data stored at the LUN 22. From the proprietary information record 600-5, it is known that the server SV3 is the proprietary of the LUN 31 and of data stored at the LUN 31.

The storage devices ST1 to ST3, for example, when connecting to a server, respectively create proprietary information and record the information to the proprietary information table 600 of the storage devices ST1 to ST3. Further, the storage devices ST1 to ST3 each transmit the proprietary information created therein, to other directly connected storage devices and further transfer received proprietary information to other storage devices. Consequently, in the storage devices ST1 to ST3, the proprietary information of the servers SV1 to SV3 may be shared.

FIG. 7 is a schematic of an example of the contents of an authorization information table. In FIG. 7, an authorization information table 700 includes a server name field, a LUN ID information field, an authorization type field, and an authorization flag. By entering information in the fields, authorization information is stored as records.

Here, a server name is an identifier of the servers SV1 to SV3. LUN ID information is an identifier of a LUN for which the server is the proprietary. In this example, LUN ID information is expressed as a combination of a LUN number and a server name. Authority types include a logical-volume (LUN in the drawing) utilization authority and a data (DATA in the drawing) utilization authority. Logical-volume utilization authority is authority to replicate arbitrary data to a given logical volume. Data utilization authority is authority to replicate given data of an arbitrary logical volume.

An authorization flag is a flag that indicates whether authorization has been given in regard to an authorization request. The authorization flag is set to “OFF” in an initial state. If authorization is given in regard to an authorization request, the corresponding flag is set to “ON”. On the other hand, if no authorization is given for the authorization request, the authorization flag remains set to “OFF”.

From the authorization information record 700-1, it is known that the server SV1 has authority to use the LUN 21, for which the server SV2 is the proprietary. From the authorization information record 700-2, it is known that the server SV2 has authority to use the data stored at the LUN 11, of which the server SV1 is the proprietary.

From the authorization information record 700-3, it is known that the server SV3 has authority to use the data stored at the LUN 12, of which the server SV1 is the proprietary. The records in the authorization information table 700 are deleted when the corresponding LUN is deleted. For example, if the LUN 21 in the storage device ST2 is deleted, the authorization information record 700-1 is deleted.

Next, a functional configuration of the storage devices ST1 to ST3 according to the present embodiment will be described. In the description, unless otherwise indicated, an arbitrary storage device in the storage system according to the present embodiment is indicated as “storage device ST” and an arbitrary server is indicated as “server SV”.

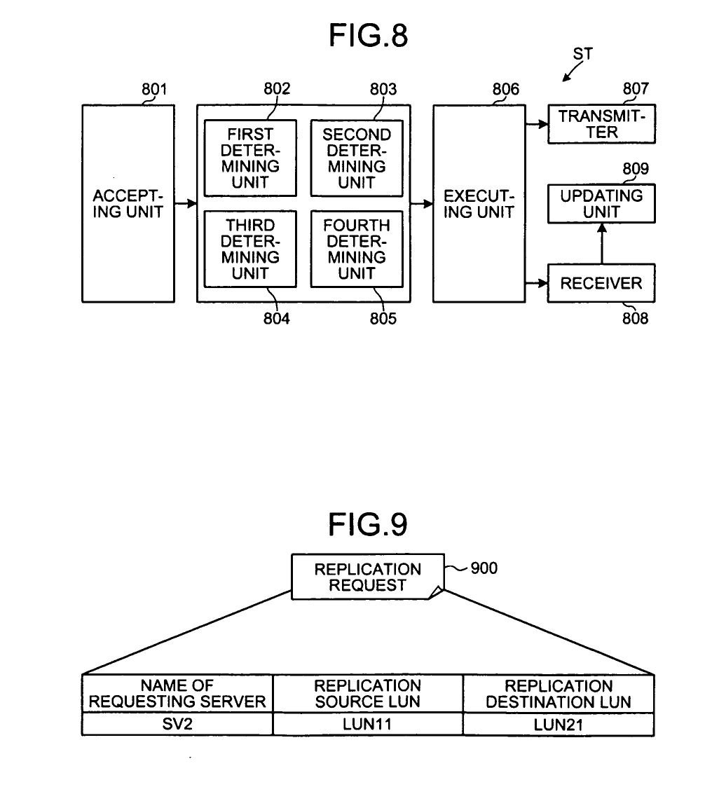

FIG. 8 is a block diagram of a function configuration of a storage device. In FIG. 8, the storage device ST includes a accepting unit 801, a first determining unit 802, a second determining unit 803, a third determining unit 804, a fourth determining unit 805, an executing unit 806, a transmitter 807, a receiver 808, and an updating unit 809. Functions of the functional units (the accepting unit 801 to the updating unit 809) are, for example, implemented by executing on the CPU 201, a program stored to a recording device such as the ROM 202, the RAM 203, and the HDD 204 depicted in FIG. 2, or via the I/F 205. Process results of the functional units, unless otherwise indicated, are stored to a recording device such as the RAM 203 and the HDD 204. Further, when an example of a function unit process is described, description will be given using the storage device ST2 depicted in FIG. 3 as an example.

The accepting unit 801 accepts a replication request that concerns the replication destination LUN of target data and is from a server SV that is a requesting server among the servers SV. For example, the accepting unit 801 may accept the replication request directly from server SV or via another storage device ST. Here, a detailed example of a replication request will be described.

FIG. 9 is a schematic of an example of a replication request. In FIG. 9, a replication request 900 is information that includes the requesting server name, the LUN of the replication source and the LUN of the replication destination. Here, the requesting server name is the name of the server that has issued the replication request 900. The replication source LUN is the number of the LUN storing the target data. The replication destination LUN is the number of the LUN to which data is replicated. For example, the replication request 900 is a replication request from the server SV2 and requesting replication of target data at the LUN 11 of the storage device ST1, to the LUN 21 of the storage device ST2.

In FIG. 8, if the accepting unit 801 accepts a replication request, the first determining unit 802 determines whether the identifier of the requesting server SV is included in a table storing the identifiers of servers SV that are operable to access the target data. Here, a server that is operable to access the target data is the server that is the proprietary of the target data.

In other words, the first determining unit 802 determines whether the requesting server SV is the proprietary of the target data. A table storing the identifiers of servers SV that are operable to access the target data is, for example, the proprietary information table 600 depicted in FIG. 6.

For example, if the replication request 900 depicted in FIG. 9 is accepted, the first determining unit 802 searches the proprietary information table 600, for a proprietary information record that has the LUN number “LUN 11” of the replication source in the LUN ID information field. Here, the proprietary information record 600-1 is retrieved.

The first determining unit 802 determines whether the server identifier in the data proprietary field of the retrieved proprietary information record coincides with the identifier “SV2” of the requesting server SV2. Here, if the identifier coincides with that of the server SV2, the first determining unit 802 determines that the identifier of the requesting server is included in the table, i.e., the requesting server SV is the proprietary of the target data.

On the other hand, if the identifier does not coincide with that of the server SV2, the first determining unit 802 determines that the identifier of the requesting server is not included in the table, i.e., the requesting server SV is not the proprietary of the target data. In this example, the server identifier “SV1” in the data proprietary field of the retrieved proprietary information record 600-1 does not coincide with the identifier “SV2” of the requesting server SV2 and therefore, the first determining unit 802 determines that the identifier of the requesting server is not included in the table.

If a proprietary information record that includes the LUN of the replication source in the LUN ID information field is not found in the proprietary information table 600, configuration may be such that the first determining unit 802 determines that the identifier of the requesting server is included in the table, i.e., assumes that for data at a LUN for which proprietary information has yet to be registered in the proprietary information table 600, a server SV that is the proprietary does not exist and thus, the first determining unit 802 regards an arbitrary server SV to be a proprietary.

If a replication request has been accepted, the second determining unit 803 determines whether the identifier of the requesting server is included in a table that stores the identifiers of servers SV having authority to replicate the target data with respect to an arbitrary storage area. Here, a server that is authorized to replicate the target data with respect to an arbitrary storage area is a server that has authority to use the target data.

In other words, the second determining unit 803 determines whether the requesting server SV has authority to use the target data. A table that stores the identifiers of servers SV having authority to replicate the target data with respect to an arbitrary storage area is, for example, the authorization information table 700 depicted in FIG. 7.

For example, if the replication request 900 is accepted, the second determining unit 803 searches the authorization information table 700, for an authorization information record that has the LUN number “LUN 11” of the replication source in the LUN ID information field and that has “DATA” in the authorization type field. In this example, the authorization information record 700-2 is retrieved.

The second determining unit 803 determines whether the authorization flag in the retrieved authorization information record is set to “ON”. Here, if the authorization flag is set to “ON”, the second determining unit 803 determines that the identifier of the requesting server SV is included in the table, i.e., the requesting server SV has authority to use the target data.

On the other hand, if the authorization flag is not set to “ON”, the second determining unit 803 determines that the identifier of the requesting server SV is not included in the table, i.e., the requesting server SV does not have authority to replicate the target data. In this example, the authorization flag in the authorization information record 700-2 is set to “ON” and therefore, the identifier of the requesting server is included in the table.

If an authorization information record that has the LUN of the replication source in the LUN ID information field and “DATA” in the authorization type field is not found in the authorization information table 700, the second determining unit 803 determines that the identifier of the requesting server is not included in the table, i.e., a server SV having authority to use the target data does not exist.

If a replication request is accepted, the third determining unit 804 determines whether the identifier of the requesting server SV is included in a table that stores the identifiers of servers that are operable to access the replication destination LUN. Here a server SV that is operable to access the replication destination LUN is the server that is the proprietary of the replication destination LUN. In other words, the third determining unit 804 determines whether the requesting server SV is the proprietary of the replication destination LUN.

For example, if the replication request 900 is accepted, the third determining unit 804 searches the proprietary information table 600, for a proprietary information record that has the LUN number “LUN 21” of the replication destination in the LUN ID information field. In this example, the proprietary information record 600-3 is retrieved.

The third determining unit 804 determines whether the server identifier set in the server name field of the retrieved proprietary information record coincides with the identifier “SV2” of the requesting server SV2. Here, if the identifier coincides with that of the requesting server SV2, the third determining unit 804 determines that identifier of the requesting server is included in the table, i.e., the requesting server SV is the proprietary of the replication destination LUN.

On the other hand, if the identifier does not coincide with that of the requesting server SV2, the third determining unit 804 determines that the identifier of the requesting server SV is not included in the table, i.e., the requesting server SV is not the proprietary of the replication destination LUN. In this example, the server name “SV2” set in the server name field of the retrieved proprietary information record 600-3 coincides with the identifier of the requesting server SV2 “SV2” and therefore, the identifier of the requesting server SV is determined to be included in the table.

If a proprietary information record that includes the LUN of the replication destination in the LUN ID information field is not found in the proprietary information table 600, configuration may be such that the third determining unit 804 determines that the identifier of the requesting server is included in the table, i.e., assumes that for a LUN for which proprietary information has yet to be registered in the proprietary information table 600, a server SV that is the proprietary thereof does not exist and thus, the third determining unit 804 regards an arbitrary server SV as a proprietary.

If a replication request is accepted, the fourth determining unit 805 determines whether the identifier of the requesting server SV is included in a table that stores the identifiers of servers SV having authority to replicate arbitrary data to a replication destination of a given LUN. Here, a server that has authority to replicate arbitrary data to a given replication destination LUN is a server that has authority to use the given replication destination LUN. In other words, the fourth determining unit 805 determines whether the requesting server SV has authority to use the given replication destination LUN.

For example, if the replication request 900 is accepted, the fourth determining unit 805 searches the authorization information table 700, for an authorization information record that has the LUN number “LUN 11” of the replication destination in the LUN ID information field and that has “LUN” in the authorization type field. The fourth determining unit 805 determines whether the authorization flag in the retrieved authorization information is set to “ON”.

Here, if the authorization flag is set to “ON”, the fourth determining unit 805 determines that the identifier of the requesting server is included in the table, i.e., the requesting server SV has authority to use the replication destination LUN. On the other hand, if the authorization flag is set to “OFF”, the fourth determining unit 805 determines that the identifier of the requesting server is not included in the table, i.e., the requesting server SV does not have authority to use the replication destination LUN.

In this example, an authorization information record that has the LUN number “LUN 11” of the replication destination LUN in the LUN ID information field and that has “LUN” in the authorization type field is not found in the authorization information table 700. In this case, the fourth determining unit 805 determines that the identifier of the requesting server is not included in the table, i.e., a server SV having authority to use the replication destination LUN does not exist.

The executing unit 806 executes a replication process of replicating target data to a replication destination LUN. The replication process varies depending on whether the storage device ST is a storage device ST on the target data transmission side or a storage device ST the reception side. If the storage device ST is a storage device ST on the transmission side, the executing unit 806 thereof, for example, transmits target data that is at a replication source LUN of the storage device ST on the transmission side, to a storage device ST having the replication destination LUN.

On the other hand, if the storage device ST is a storage device ST on the reception side, the executing unit 806 thereof, for example, transmits to the storage device ST on the transmission side having the replication source LUN, a startup instruction for the replication process. As a result, the executing unit 806 of the storage device ST on the transmission side transmits target data at the replication source LUN therein, to the storage device ST on the reception side.

Here, configuration may be such that the executing unit 806 executes the replication process, if the first determining unit 802 or the second determining unit 803 determines that the identifier of the requesting server is included in the table. As a result, if the requesting server SV is the proprietary of or has authority to use the target data, the replication process is executed in response to replication request.

Further, configuration may be such that the executing unit 806 executes the replication process, if the third determining unit 804 or the fourth determining unit 805 determines that the identifier of the requesting server SV is included in the table. As a result, if the requesting server SV is the proprietary of or has authority to use the replication destination LUN, the replication process is executed in response to the replication request.

Configuration may be such that the executing unit 806 executes the replication process, if the first determining unit 802 or the second determining unit 803 determines that the identifier of the requesting server SV is included in the table and if the third determining unit 804 or the fourth determining unit 805 determines that the identifier of the requesting server SV is included in the table. As a result, if the requesting server SV is the proprietary of or has authority to use the target data, and is the proprietary of or has authority to use the replication destination LUN, the replication process is executed in response to the replication request.

Configuration may be such that the executing unit 806 executes the replication process, if the first determining unit 802 determines that the identifier of the requesting server SV is included in the table and if the third determining unit 804 determines that the identifier of the requesting server SV is included in the table. As a result, if the requesting server SV is the proprietary of the target data and of the replication destination LUN, the replication process is executed in response to the replication request.

Configuration may be such that the executing unit 806 executes the replication process, if the second determining unit 803 determines that the identifier of the server SV is included in the table and if the fourth determining unit 805 determines that the identifier of the requesting server SV is included in the table. As a result, if the requesting server SV has authority to use the target data and to use the replication destination LUN, the replication process is executed in response to the replication request.

Configuration may be such that the executing unit 806 executes the replication process, if the first determining unit 802 determines that the identifier of the requesting server SV is included in the table and if the fourth determining unit 805 determines that the identifier if the requesting server SV is included in the table. As a result, if the requesting server SV is the proprietary of the target data and has authority to use the replication destination LUN, the replication process is executed in response to the replication request.

Further, configuration may be such that the executing unit 806 executes the replication process, if the second determining unit 803 determines that the identifier of the requesting server SV is included in the table and if the third determining unit 804 determines that the identifier of the requesting server SV is included in the table. As a result, if the requesting server SV has authority to use the target data and is the proprietary of the replication destination LUN, the replication process is executed in response to the replication request.

Further, configuration may be such that when target data is replicated to a replication destination LUN, the original proprietary server SV of the target data remains the proprietary of the target data. In this case, in the replication process executed by the executing unit 806, the target data and LUN management information are replicated from the replication source LUN to the replication destination LUN. LUN management information is information for managing servers SV set as the proprietary of target data. Here, LUN data configuration is described.

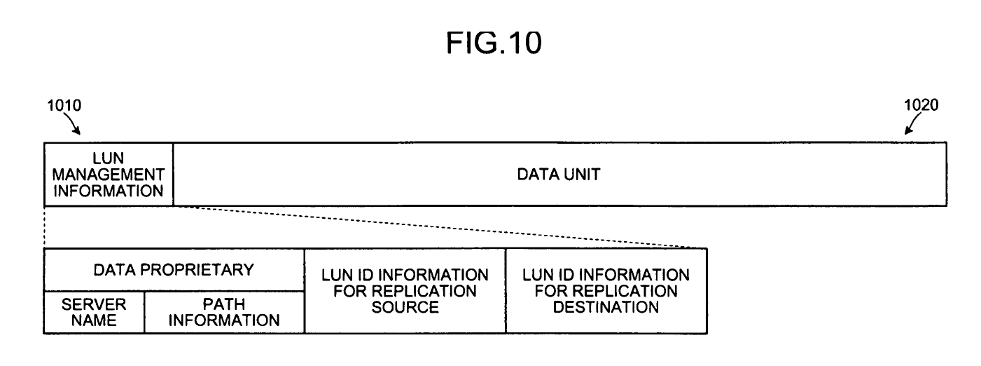

FIG. 10 is a schematic of an example of LUN data configuration. As depicted in FIG. 10, LUN data configuration includes LUN management information 1010 and a data unit 1020. The storage device ST may access both the LUN management information 1010 and the data unit 1020. On the contrary, the server SV may access only the data unit 1020.

The LUN management information 1010 includes data proprietary, LUN ID information for the replication source, and LUN ID information for the replication destination. Data proprietary is information for identifying a server SV set as the proprietary of data in the data unit 1020. In this example, data proprietary is expressed by a combination of a server name and path information. Data proprietaries are set by the storage device ST, when a server SV first writes data to the data unit 1020.

LUN ID information for the replication source is the LUN ID information of the LUN that is the replication source of the data in the data unit 1020. LUN ID information for the replication destination is the LUN ID information of the LUN that is the replication destination of the data in the data unit 1020. LUN ID information for the replication source and LUN ID information for the replication destination are updated by the storage device ST on the transmission side, when the replication process is started.

The LUN management information 1010 and the target data are replicated from the replication source LUN to the replication destination LUN, when the replication process is executed. Consequently, the contents of the LUN management information 1010 updated by the storage device ST on the transmission side are transmitted to the storage device ST on the transmission side.

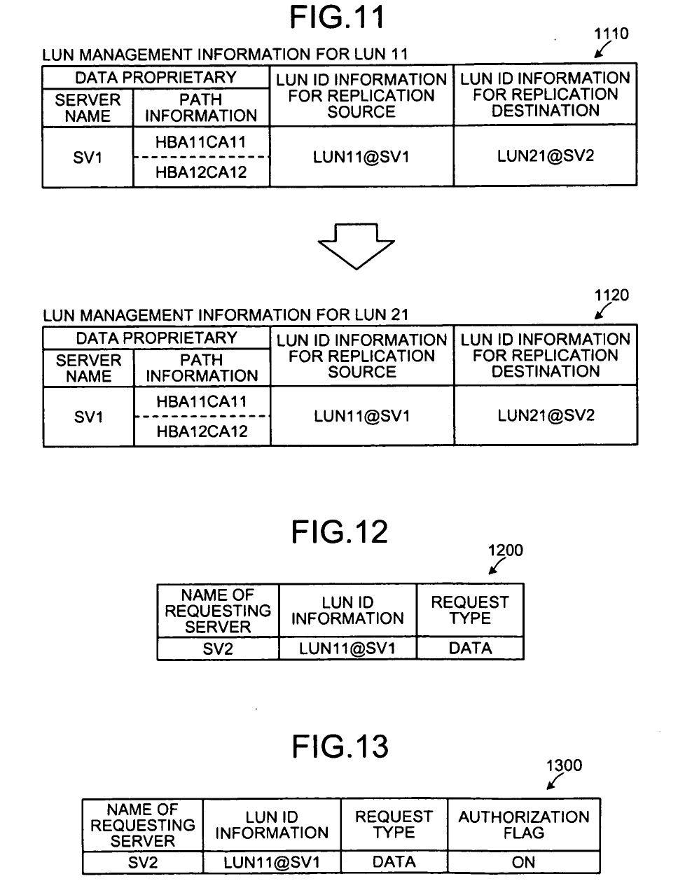

FIG. 11 is a schematic of an example of LUN management information transmission. In FIG. 11, LUN management information 1110 is the LUN management information for the LUN 11 in the storage device ST1. LUN management information 1120 is the LUN management information of the LUN 21 in the storage device ST2.

In this example, a transmission example of the contents of the LUN management information, when data at the LUN 11 (of which the server SV1 is the proprietary) is replicated to the LUN 21. For example, as a result of data at the LUN 11 being replicated to the LUN 21, the contents of the LUN management information 1110 of the LUN 11 are reflected in the LUN management information 1120 for the LUN 21.

When the LUN management information 1120 for the LUN 21 is updated, the storage device ST updates the proprietary information record 600-3 in the proprietary information table 600. For example, the storage device ST2 changes the data proprietary field in the proprietary information record 600-3 from “SV2” to “SV1”.

The storage device ST2 refers to the server information table 520 and broadcasts the updated proprietary information record 600-3 to the other storage devices ST1 and ST3 in the storage system 300. The storage devices ST1 and ST3 register (overwrite) the updated proprietary information record 600-3 to the proprietary information table 600, whereby the change of the data proprietary of the data at the LUN 21 may be reflected in the proprietary information tables 600 of the storage devices ST1 and ST3.

If data at the LUN 21 of which the server SV1 is the proprietary is replicated to the LUN 31 in the storage device ST3, the contents of the LUN management information 1120 for the LUN 21 are updated. For example, in the LUN management information 1120, the LUN ID information for the replication source is updated to “LUN 21@SV2” and the LUN ID information for the replication destination is updated to “LUN 31@SV3”. When data at the LUN 21 is replicated to the LUN 31, the contents of the LUN management information 1120 for the LUN 21 are reflected in the LUN management information for the LUN 31.

The accepting unit 801 accepts from the requesting server SV, a data authorization request requesting authority to replicate target data to an arbitrary LUN. A data authorization request is a request for authority to use the target data. For example, if the server SV2 is to replicate data from the LUN 11 of the storage device ST1, authority to use the data of the LUN 11 is needed. Here, a data authorization request 1200 used by the server SV2 to request authority to use the data of the LUN 11 will be described.

FIG. 12 is a schematic of an example of a data authorization request. In FIG. 12, the data authorization request 1200 includes the name of the requesting server, LUN ID information and the request type. Here, the name of the requesting server is the identifier of the server that has issued the data authorization request 1200. The LUN ID information is the LUN ID information of the replication source LUN storing the target data for which utilization authority is requested. The request type indicates for what the utilization authority is being requested. In this example, since utilization authority for the target data is being requested, the request type is set as “DATA”.

For example, the data authorization request 1200 is a request for the requesting server SV2 to have authority (utilization authority) to replicate the target data at the LUN 11 in the server SV1. The data authorization request 1200, for example, is transmitted from the server SV2 to the storage device ST2, by an execution of a data authorization request command at the server SV2.

In FIG. 8, the transmitter 807 transmits the accepted data authorization request to other storage devices ST directly connected to other servers SV that is operable to access the target data. For example, the transmitter 807 refers to the server information table 520 and broadcasts the data authorization request 1200 to the other storage devices ST1 and ST3 that are in the storage system 300 and different from the storage device ST2.

The receiver 808 receives from the other storage devices ST, data authorization responses from other servers SV in response to the transmitted data authorization request. Here, a data authorization response is a response to a data authorization request and indicates whether authority to use the target data is granted.

FIG. 13 is a schematic of an example of a data authorization response. In FIG. 13, a data authorization response 1300 is a response from the server SV1, received in response to the data authorization request 1200 depicted in FIG. 12. The data authorization response 1300 includes the name of the requesting server, LUN ID information, the request type, and an authorization flag.

Here, the name of the requesting server name is the identifier of the server that has issued the data authorization request 1200. LUN ID information is the LUN ID information for the replication source LUN storing the target data for which utilization authority is requested. The request type indicates for what the utilization authority is being requested. In this example, utilization authority for the target data is being requested and therefore, the request type is set as “DATA”.

An authorization flag is a flag that indicates the results of the response to the data authorization request. In this example, if authority to use the target data is granted, the authorization flag is set to “ON”, whereas if authority to use the target data is not granted, the authorization flag is set to “OFF”. In the example depicted in FIG. 13, authority to use the target data has been granted and therefore, the authorization flag is set to “ON”.

In FIG. 8, the updating unit 809, based on the received data authorization response, updates a table storing the identifiers of servers SV having authority to replicate the target data with respect to an arbitrary storage area. For example, the updating unit 809 registers the received data authorization response 1300, as new authorization information (corresponds to the authorization information record 700-2 depicted in FIG. 7), to the authorization information table 700. Consequently, the results of the response to the data authorization request may be reflected in the authorization information table 700.

The receiver 808 receives from another storage device ST directly connected to another server SV, a data authorization request that is from the other server SV and that requests authority to replicate data accessible by a server SV directly connected to the storage device ST of the receiver 808. For example, in the case of the data authorization request 1200, the receiver 808 of the storage device ST1 receives from the storage device ST2 directly connected to the server SV2, a data authorization request requesting utilization authority for data of which the server SV1, which is directly connected to the storage device ST1, is the proprietary.

In this case, the transmitter 807 of the storage device ST1 notifies the server SV1 of the received data authorization request. At the server SV1, it is determined whether the requested utilization authority for the data is to be granted. Whether utilization authority is granted is, for example, determined by the user of the server SV1. Configuration may be such that the user of the server SV1 preliminarily creates utilization authority information and stores the utilization authority information to the server SV1, whereby the server SV1 automatically determines whether utilization authority for the data is to be granted.

Here, utilization authority information is, for example, information indicating utilization authority for data. The server SV1, for example, determines whether the server SV2 is registered in the utilization authority information that indicates the servers SV having utilization authority for the data concerned in the data authorization request. The server SV1 grants utilization authority for the data, if the server SV2 is registered in the utilization authority information. On the contrary, if the server SV2 is not registered in the utilization authority information, the server SV1 does not grant utilization authority for the data.

The server SV1 transmits to the storage device ST1, a data authorization response indicating the response to the data authorization request. The receiver 808 receives the data authorization response transmitted from the server SV1 and the transmitter 807 transmits the received data authorization response to the storage device ST2.

If the name of a server SV directly connected to the storage device ST of the receiver 808 is not included in the LUN ID information of the data authorization request received by the receiver 808, the data authorization request may be discarded. In other words, in this example, if the received data authorization request is not for a server directly connected to the storage device ST1, the data authorization request is discarded.

The accepting unit 801 accepts from the requesting server SV, a LUN authorization request requesting authority to replicate arbitrary data to a given replication destination LUN. A LUN authorization request is a request for authority to use a given replication destination LUN. For example, if the server SV2 is to replicate data to the LUN 11 of the storage device ST1, utilization authority for the LUN 11 is needed. Here, a LUN authorization request 1400 used by the server SV2 to request authority to use the LUN 11 will be described.

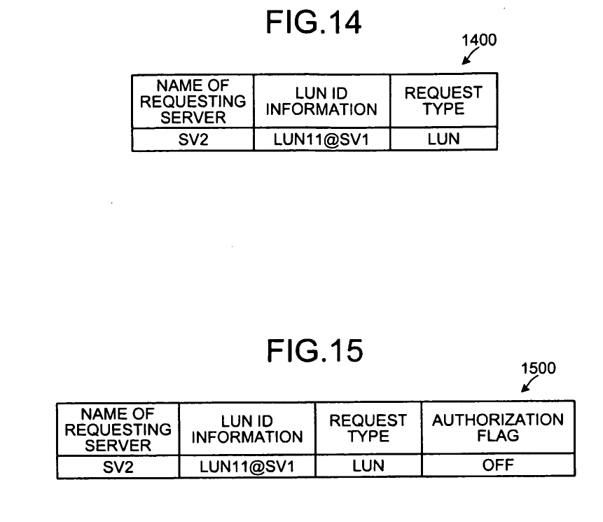

FIG. 14 is a schematic of an example of a LUN authorization request. In FIG. 14, the LUN authorization request 1400 includes the name of the requesting server, LUN ID information, and the request type. Here, the name of the requesting server is the identifier of the server that has issued the LUN authorization request 1400. LUN ID information is the LUN ID information of the replication destination LUN for which utilization authority is requested. The request type indicates for what the utilization authority is being requested. In this example, since utilization authority for the replication destination LUN is being requested, the request type is set as “LUN”.

For example, the LUN authorization request 1400 is a request for the requesting server SV2 to have authority (utilization authority) to replicate arbitrary data in the LUN 11 of the server SV1. The LUN authorization request 1400, for example, is transmitted from the server SV2 to the storage device ST2, by an execution of a LUN authorization request command at the server SV2.

In FIG. 8, the transmitter 807 transmits the accepted LUN authorization request to other storage devices ST directly connected to other servers that is operable to access the replication destination LUN. For example, the transmitter 807 refers to the server information table 520 and broadcasts the LUN authorization request 1400 to the other storage devices ST1 and ST3 that are in the storage system 300 and different from the storage device ST2.

The receiver 808 receives from the other storage devices ST, LUN authorization responses from other servers SV in response to transmitted LUN authorization request. Here, a LUN authorization response is a response to a LUN authorization request and indicates whether authority to use the replication destination LUN is granted.

FIG. 15 is a schematic of an example of a LUN authorization response. In FIG. 15, a LUN authorization response 1500 is a response from the server SV1, received in response to the LUN authorization request 1400 depicted in FIG. 14. The LUN authorization response 1500 includes the name of the requesting server, LUN ID information, the request type, and an authorization flag.

Here, the name of the requesting name is the identifier of the server that has issued the LUN authorization request 1400. LUN ID information is the LUN ID information of the replication destination LUN for which utilization authority is requested. The request type indicates for what the utilization authority is being requested. In this example, utilization authority for the replication destination LUN is being requested and therefore, the request type is set as “LUN”.

An authorization flag is a flag that indicates the results of the response to the LUN authorization request. In this example, if authority to use the replication destination LUN is granted, the authorization flag is set to “ON”, whereas if authority to use the replication destination LUN is not granted, the authorization flag is set to “OFF”. In the example depicted in FIG. 15, authority to use the replication destination is not granted and therefore, the authorization flag is set to “OFF”.

In FIG. 8, the updating unit 809, based on the received LUN authorization response, updates a table storing the identifiers of servers SV having authority to replicate arbitrary data to the replication destination LUN. For example, the updating unit 809 registers the received LUN authorization response 1500, as new authorization information, to the authorization information table 700. Consequently, the results of the response to the LUN authorization request may be reflected in the authorization information table 700.

The receiver 808 receives from another storage device ST directly connected to another server SV, a LUN authorization request that is from the other server SV and that requests authority to replicate arbitrary data to a LUN accessible by a server directly connected to the storage device ST of the receiver 808. For example, in the case of the LUN authorization request 1400, the receiver 808 of the storage device ST1 receives from the storage device ST2 directly connected to the server SV2, a LUN authorization request requesting utilization authority for a LUN of which the server SV1, which is directly connected to the storage device ST1, is the proprietary.

In this case, the transmitter 807 of the storage ST1 notifies the server SV1 of the received LUN authorization request. At the server SV1, it is determined whether the requested utilization authority for the LUN is to be granted. Whether utilization authority for the LUN is granted is, for example, determined by the user of the server SV1.

The server SV1 transmits to the storage device ST1, a LUN authorization response indicating the response to the LUN authorization request. The receiver 808 receives the LUN authorization response transmitted from the server SV1 and the transmitter 807 transmits the received LUN authorization response to the storage device ST2.

Configuration may be such that if the name of a server SV directly connected to the storage device ST of the receiver is not included in the LUN ID information of the LUN authorization request received by the receiver 808, the LUN authorization request is discarded. In other words, if the received LUN authorization request is not for a server SV directly connected to the storage device ST1, the LUN authorization request is discarded.

To strengthen security, data authorization requests, data authorization responses, LUN authorization requests, and LUN authorization responses, etc. transmitted and received between the storage devices may be encrypted. Here, an example of encryption of the data authorization request 1200 used by the server SV2 to request utilization authority for data at the LUN 11 of which the server SV1 is the proprietary, will be described.

For example, the storage device ST2 uses a common key possessed by the storage devices ST1 and ST2 to encrypt and transmit the data authorization request 1200. In this case, the storage device ST1 decrypts the encrypted data authorization request 1200 using the common key possessed by the storage devices ST1 and ST2.

The common key possessed by the storage devices ST1 and ST2 is created, for example, using the world-wide name (WWN) of the RA 11 and the RA 21 connecting the storage devices ST1 and ST2. Further, the common key may be created using the WWN of a CA (e.g., CA 11, CA 12, CA 21, CA 22) of the storage devices ST1 and ST2.

To remove invalid data authorization requests posing to be from the server SV2, the authentication scheme described hereinafter may be adopted. The storage device ST2 uses the common key possessed by the storage devices ST1 and ST2 to encrypt and transmit to the storage device ST1 and the server SV2, the data authorization request 1200.

The server SV2 transmits the encrypted data authorization request 1200 to the server SV1 via the network 214. The server SV1 transmits the encrypted data authorization request 1200 to the storage device ST1.

The storage device ST1 uses the common key possessed by the storage devices ST1 and ST2 to decrypt the encrypted data authorization request 1200 from the server SV1 and the encrypted data authorization request 1200 from the storage device ST2. The storage device ST1 determines whether the decrypted data authorization request 1200 from the server SV1 and the decrypted data authorization request 1200 from the storage device ST2 coincide.

Here, if the decrypted data authorization requests 1200 coincide, the storage device ST1 notifies the server SV1 of the data authorization request 1200. On the other hand, if the decrypted data authorization requests 1200 do not coincide, the storage device ST1 discards the data authorization request 1200. As a result, invalid data authorization requests posing to be from the server SV2 may be removed.

In the description above, although the encrypted data authorization request 1200 is transmitted from the server SV2 to the server SV1 via the network 214, configuration is not limited hereto. For example, configuration may be such that the user of the server SV2 stores the encrypted data authorization request 1200 to a portable auxiliary recording device and hands over the auxiliary recording device to the user of the server SV1. As a result, the user of the server SV1 uses the auxiliary recording device and directly inputs the encrypted data authorization request 1200 to the server SV1.

In the description above, although the server SV is notified of a data authorization request/LUN authorization request to determine whether utilization authority is to be granted for the data/LUN requested by the data authorization request/LUN authorization request, configuration is not limited hereto. For example, the storage device ST that receives the data authorization request or the LUN authorization request may determine whether utilization authority is granted.

For example, the storage device ST may grant utilization authority for data with respect to a data authorization request from a given server SV. Further, the storage device ST may grant utilization authority for data with respect to a data authorization request from a given server SV of a given time slot.

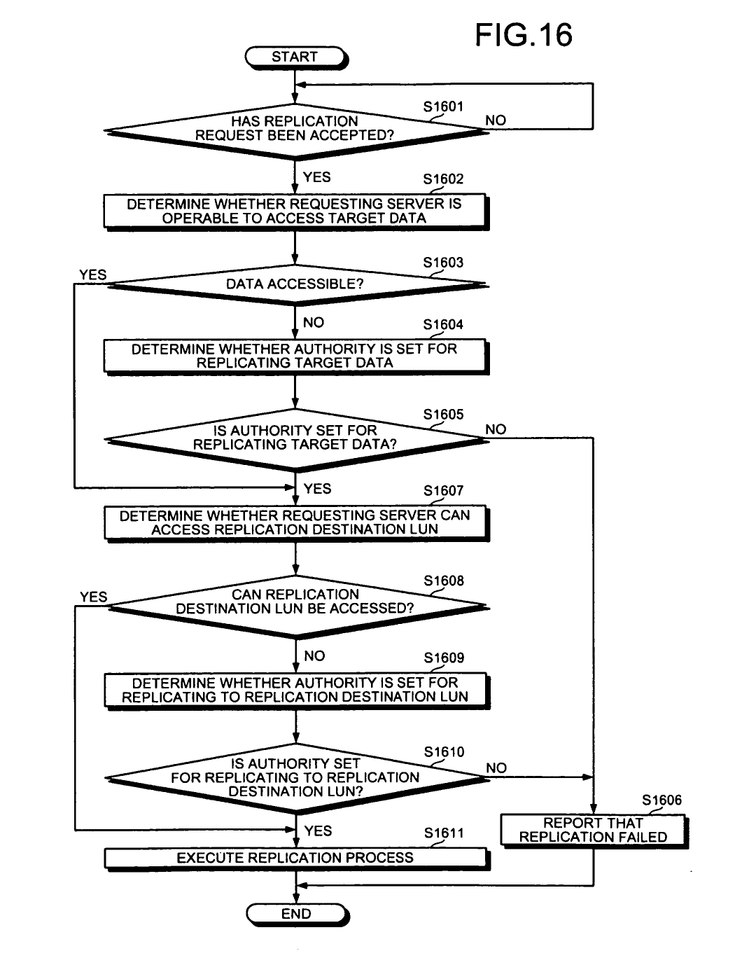

FIG. 16 is a flowchart of a data replication process by the storage device according to the present embodiment. In the flowchart depicted in FIG. 16, the accepting unit 801 determines whether a replication request that is from a requesting server SV and for the replication destination LUN of target data has been accepted (operation S1601).

Here, acceptance of a replication request is awaited (operation S1601: NO), when a replication request is accepted (operation S1601: YES), the first determining unit 802 determines whether the requesting server SV may access the target data (operation S1602). For example, the first determining unit 802 determines whether the identifier of the requesting server SV is included in a table that indicates the identifiers of servers SV that is operable to access the target data.

Here, if the requesting server SV may access the target data (operation S1603: YES), the storage device proceeds to operation S1607. On the other hand, if the requesting server SV may not access the target data (operation S1603: NO), the second determining unit 803 determines whether the requesting server SV has authority to replicate target data with respect to an arbitrary LUN (operation S1604). For example, the second determining unit 803 determines whether the identifier of the requesting server SV is included in a table that indicates the identifiers of servers SV that have authority to replicate the target data with respect to an arbitrary LUN.

Here, if the requesting server SV does not have authority to replicate the target data (operation S1605: NO), the transmitter 807 notifies the requesting server SV that replication failed (operation S1606), ending the process according to the flowchart.

On the other hand, if the requesting server SV has authority to replicate the target data (operation S1605: YES), the third determining unit 804 determines whether the requesting server SV may access the replication destination LUN (operation S1607). For example, the third determining unit 804 determines whether the identifier of the requesting server SV is included in a table that indicates the identifiers of servers SV that are operable to access the replication destination LUN.

Here, if the requesting server SV may access the replication destination LUN (operation S1608: YES), the storage device proceeds to operation S1611. On the other hand, if the requesting server SV may not access the replication destination LUN (operation S1608: NO), the fourth determining unit 805 determines whether the requesting server SV has authority to replicate arbitrary data to the replication destination LUN (operation S1609). For example, the fourth determining unit 805 determines whether the identifier of the requesting server SV is included in a table that indicates the identifiers of the servers SV that have authority to replicate arbitrary data to the replication destination LUN.

Here, if the identifier of the requesting server SV does not have authority to replicate to the replication destination LUN (operation S1610: NO), the transmitter 807 notifies the requesting server SV that replication failed (operation S1606), ending the process according to the flowchart.

On the other hand, if the requesting server SV has authority to replicate to the replication destination LUN (operation S1610: YES), the executing unit 806 executes the replication process of replicating the target data to the replication destination LUN (operation S1611), ending the process according to the flowchart.

Consequently, a configuration is enabled where the replication process of replicating the target data to the replication destination LUN is executed only if the requesting server SV is the proprietary of or has utilization authority for the target data, and is the proprietary of or has utilization authority for the replication destination LUN.

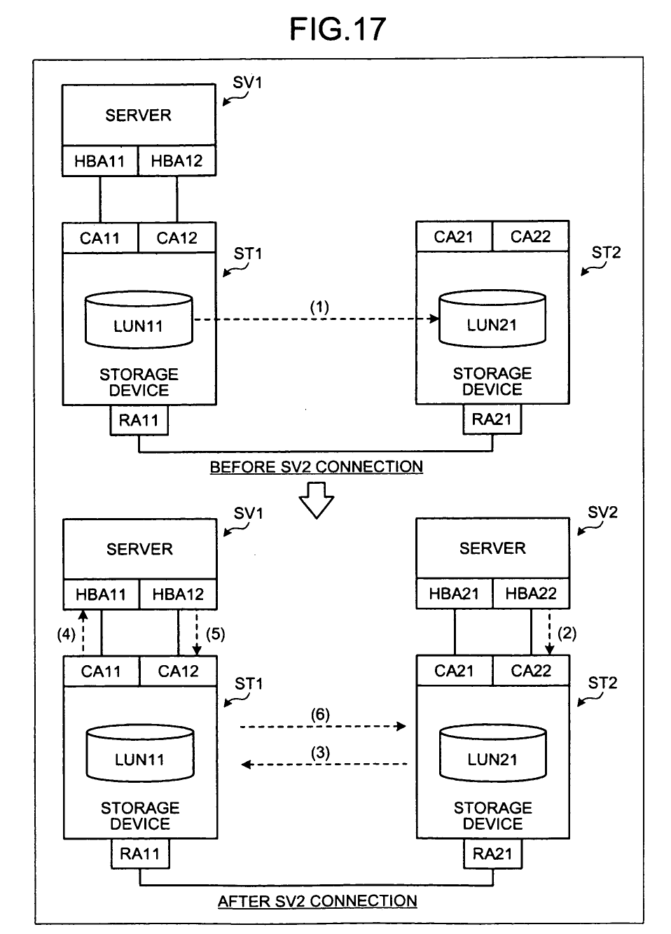

FIG. 17 is a schematic of a first example of application of the data replication scheme. In FIG. 17, (1) data at the LUN 11 that is in the storage device ST1 and for which the server SV1 is the proprietary is replicated to the LUN 21 in the storage device ST2.

Further, as depicted in FIG. 17, the server SV2 is newly connected to the storage device ST2. In this case, since the proprietary of the data at the LUN 21 in the storage device ST2 is the server SV1, the server SV2 may not access the data at the LUN 21 in the storage device ST2.

To access the data at the LUN 21 in the storage device ST2, the server SV2 needs to receive from the server SV1, utilization authority for the data at the LUN 21. Hence, (2) the server SV2 transmits to the storage device ST2, a data authorization request concerning the data at the LUN 21.

(3) The storage device ST2 transmits to the storage device ST1, the data authorization request received from the server SV2. (4) The storage device ST1 notifies the server SV1 of the data authorization request from the server SV2 and concerning the data at the LUN 21.

In this example, the requested utilization authority for the data at the LUN 21 is granted at the server SV1. (5) The server SV1 notifies the storage device ST1 of a data authorization response indicating that utilization authority for the data at the LUN 21 is granted. (6) The storage device ST1 transmits to the storage device ST2, the data authorization response from the server SV1.

Thereafter, the data authorization response from the server SV1 is reflected in the authorization information tables 700 of the storage devices ST1 and ST2, and the server SV2 has utilization authority for the data at the LUN 21. As a result, the server SV2 may access the data at the LUN 21 in the storage device ST2.

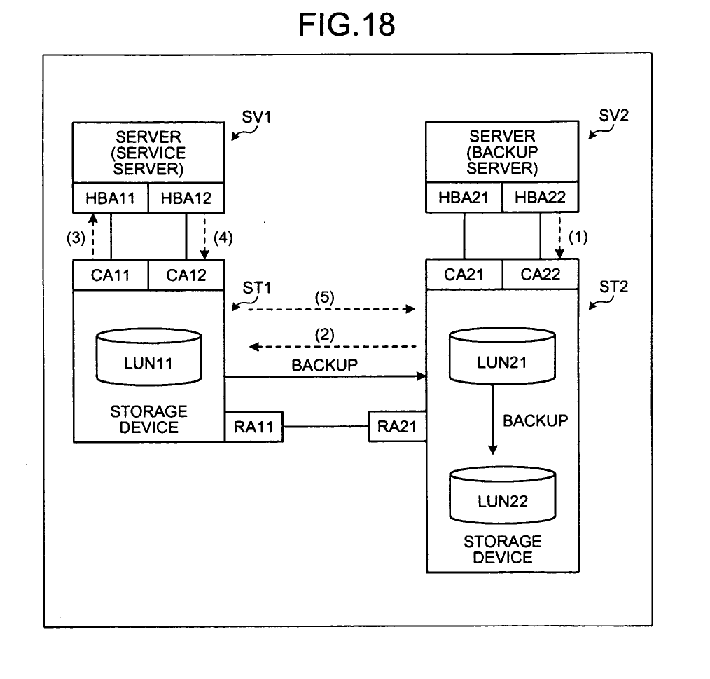

FIG. 18 is a schematic of a second example of application of the data replication scheme. In FIG. 18, the server SV1 is a service server and the server SV2 is a backup server. In this example, it is assumed that the server SV2 replicates (backs up) data at the LUN 11 in the storage device ST1, to the LUN 21 and the LUN 22 in the storage device ST2.

However, the proprietary of the data at the LUN 11 is the server SV1. The proprietary of the LUN 21 and the LUN 22 is the server SV2. In this case, to replicate the data at the LUN 11 to the LUN 21 and the LUN 22, the server SV2 needs to receive from the server SV1, utilization authority for the data the LUN 11.

Hence, (1) the server SV2 transmits to the storage device ST2, a data authorization request concerning the data at the LUN 11. (2) The storage device ST2 transmits to the storage device ST1, the data authorization request from the server SV2. (3) The storage device ST1 notifies the server SV1 of the data authorization request from the server SV2 and concerning the data at the LUN 11.

In this example, the requested utilization authority for the data at the LUN 11 is granted at the server SV1. (4) The server SV1 notifies the storage device ST1 of a data authorization response indicating that utilization authority for the data at the LUN 11 is granted. (5) The storage device ST1 transmits to the storage device ST2, the data authorization response from the server SV1.

Thereafter, the data authorization response from the server SV1 is reflected in the authorization information tables 700 of the storage devices ST1 and ST2 and the server SV2 has utilization authority for the data at the LUN 11. As a result, the server SV2 may replicate (backup) the data at the LUN 11, to the LUN 21. Furthermore, the server SV2 may replicate (multistage copy) the data at the LUN 21, to the LUN 22.

In this manner, by giving the server SV2 utilization authority for the data at the LUN 11 before the replication request concerning the data at the LUN 11, backup of the data at the LUN 11 may be performed at an arbitrary timing of the server SV2 on the receiving side. Further, by replicating the data at the LUN 11, to the LUN 21 and the LUN 22, the server SV1 may replicate the data at the LUN 21 or the data at the LUN 22, to the LUN 11, i.e., restore the data at the LUN 11.

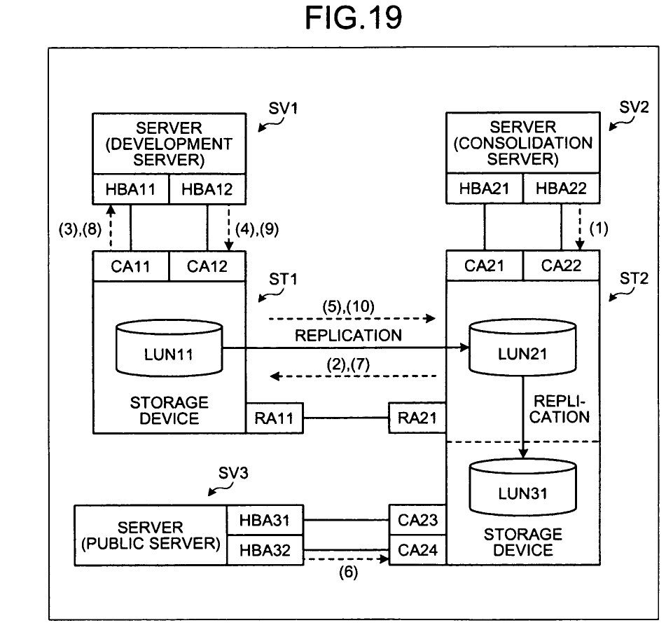

FIG. 19 is a schematic of a third example of application of the data replication scheme. In FIG. 19, the server SV1 is a development server; the server SV2 is a consolidation server, and the server SV3 is a public server. In this example, the server SV2 replicates data at the LUN 11 in the storage device ST1, to the LUN 21 in the storage device ST2. Consequently, the data (or program) at the LUN 11 and created by the server SV1 is consolidated in the LUN 21.

The server SV3 replicates the data at the LUN 21, to the LUN 31. Consequently, the data (or program) at the LUN 11 and created by the server SV1 is made available from the server SV3. However, the proprietary of the data at the LUN 11 is the server SV1. The proprietary of the LUN 21 is the server SV2. The proprietary of the LUN 31 is the server SV3.

In this case, to replicate the data at the LUN 11 to the LUN 21, the server SV2 needs to receive from the server SV1, utilization authority for the data at the LUN 11.

Hence, (1) the server SV2 transmits to the storage device ST2, a data authorization request concerning the data at the LUN 11. (2) The storage device ST2 transmits to the storage device ST1, the data authorization request received from the server SV2. (3) The storage device ST1 notifies the server SV1 of the data authorization request from the server SV2 and concerning the data at the LUN 11.

In this example, the requested utilization authority for the data at the LUN 11 is granted at the server SV1. (4) The server SV1 notifies the storage device ST1 of a data authorization response indicating that the utilization authority for the data at the LUN 11 is granted. (5) The storage device ST1 transmits to the storage device ST2, the data authorization response from the server SV1.

Thereafter, the data authorization response from the server SV1 is reflected in the authorization information tables 700 of the storage devices ST1, ST2, and ST3; and the server SV2 has utilization authority for the data at the LUN 11. As a result, the server SV2 may replicate (consolidate) data at the LUN 11, to the LUN 21.

In this manner, by giving the server SV2 utilization authority for the data at the LUN 11 before the replication request concerning the data at the LUN 11, the data at the LUN 11 may be consolidated at an arbitrary timing of the server SV2 on the receiving side.

To replicate the data at the LUN 11 to the LUN 31, the server SV3 needs to receive from the server SV1, utilization authority for the data at the LUN 11.

Hence, (6) the server SV3 transmits to the storage device ST2, a data authorization request concerning the data at the LUN 21. (7) The storage device ST2 transmits to the storage device ST1, the data authorization request from the server SV3, concerning the data at the LUN 21. (8) The storage device ST1 notifies the server SV1 of the data authorization request from the server SV3 and concerning the data at the LUN 21.

In this example, the requested utilization authority for the data at the LUN 21 is granted at the server SV1. (9) The server SV1 notifies the storage device ST1 of a data authorization response indicating that the utilization authority for the data at the LUN 21 is granted. (10) The storage device ST1 transmits to the storage device ST2, the data authorization response from the server SV1.

Thereafter, the data authorization response from the server SV1 is reflected in the authorization information tables 700 of the storage devices ST1, ST2, and ST3; and the server SV3 has utilization authority for the data at the LUN 21. As a result, the server SV3 may replicate the data at the LUN 21, to the LUN 31.

In this manner, by giving the server SV3 utilization authority for the data at the LUN 21 before the replication request concerning the data at the LUN 21, the data at the LUN 21 may be replicated at an arbitrary timing of server SV3 on the receiving side. Consequently, if the server SV3 detects at the LUN 31, data that has been damaged for some reason, the data at the LUN 21 may be replicated to the LUN 31.

In the description above, although an example has been described where the server SV3 replicated data at the LUN 21, to the LUN 31, configuration may be such that the server SV2 replicates the data at the LUN 21 to the LUN 31. However, in this case, to replicate the data at the LUN 22 to the LUN 31, the server SV2 needs to receive from the server SV3, utilization authority for the LUN 31.

As described, according to the storage device ST of the embodiment, configuration may be such that if the requesting server SV is the proprietary of or has utilization authority for the target data, and is the proprietary of or has utilization authority for the replication destination, replication of the target data to the replication destination LUN is performed.

Consequently, even if a replication request is for replication to a LUN accessible by the requesting server SV, the replication of target data of which the requesting server SV is not the proprietary or for which the requesting server SV does not have utilization authority, may be prevented. Further, even if a replication request is for target data accessible by the requesting server SV, replication to a replication destination LUN of which the requesting server SV is not the proprietary or for which the requesting server SV does not have utilization authority, may be prevented.

According to the embodiment, even if a storage device ST is not the proprietary of the target data, by giving the storage ST utilization authority for the target data before the replication request, replication of the target data to a replication destination for which the storage device ST is the proprietary or has utilization authority, may be performed.

Further, according to the embodiment, even if the storage device ST is not the proprietary of the replication destination LUN, by giving the storage device ST utilization authority for the replication destination LUN before the replication request, replication to the replication destination LUN, of target data of which the storage device ST is the proprietary or has utilization authority, may be performed.

According to the storage device ST, when target data is replicated from the replication source LUN to the replication destination LUN, management may be performed such that the server that is the proprietary of target data does not change. Consequently, even if the target data is replicated, the server SV that is the proprietary of target data may be uniquely specified.

According to the storage device ST, servers SV that are the proprietary of and/or have utilization authority for the target data and the replication destination LUN are managed by the storage device ST and therefore, consolidated management at a server integrating multiple storage devices ST is not needed.

According to the storage device ST, configuration may be such that if the requesting server SV is the proprietary of or has utilization authority for the target data, replication of the target data to the replication destination LUN is performed. Consequently, even if a replication request concerns a replication destination LUN accessible by the requesting server SV, the replication of target data of which the requesting server SV is not the proprietary or for which the requesting server SV does not have utilization authority, may be prevented.

According to the storage device ST, configuration may be such that if the requesting server SV is the proprietary of or has utilization authority for the replication destination LUN, the replication process for replicating the target data to the replication destination LUN is performed. Consequently, even if a replication request concerns target data accessible by the requesting server SV, replication to a replication destination LUN of which the requesting server SV is not the proprietary or for which the requesting server SV does not have utilization authority, may be prevented.

According to the storage device ST, configuration may be such that if the requesting server SV is the proprietary of the target data and of the replication destination LUN, replication of the target data to the replication destination LUN is performed. Consequently, replication in response to a replication request from a requesting server SV that is not the proprietary of both the target data and the replication destination LUN, may be prevented.

According to the storage device ST, configuration may be such that if the requesting server SV has utilization authority for the target data and for the replication destination LUN, replication of the target data to the replication destination LUN is performed. Consequently, replication in response to a replication request from a requesting server SV that does not have utilization authority for both the target data and the replication destination LUN, may be prevented. In other words, even if a server SV is the proprietary of both the target data and the replication destination LUN, but does not have utilization authority for both the target data and the replication destination LUN, the replication process is prohibited.

According to the storage device ST, configuration may be such that if the requesting server SV is the proprietary of the target data and has utilization authority for the replication destination LUN, replication of the target data to the replication destination LUN is performed. Consequently, performance of the replication process may be limited to being in response to a replication request from a server SV that is the proprietary of the target data and has utilization authority for the replication destination LUN.

According to the storage device ST, configuration may be such that if the requesting server SV has utilization authority for the target data and is the proprietary of the replication destination LUN, replication of the target data to the replication destination LUN is performed. Consequently, performance of the replication process may be limited to being in response to a replication request from a server SV that has utilization authority for the target data and is the proprietary of the replication destination LUN.

According the storage device, the data replication method, and the storage system of the embodiment, unauthorized data replication may be prevented.

The data replication method described in the present embodiment may be implemented by executing a prepared program on a computer such as a personal computer and a workstation. The program is stored on a non-transitory, computer-readable medium such as a hard disk, a flexible disk, a CD-ROM, an MO, and a DVD, read out from the recording medium, and executed by the computer. The program may be a transmission medium that may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage device comprising:
an accepting unit that accepts a replication request that concerns a replication storage area for target data and that is from a requesting server that is among a plurality of servers;
a first determining unit that, if a replication request is accepted by the accepting unit, determines whether an identifier of the requesting server is included in a first table that stores identifiers of the servers that satisfy a first condition;
a second determining unit that, if a replication request is accepted by the accepting unit, determines whether the identifier of the requesting server is included in a second table that stores identifiers of the servers that satisfy a second condition; and
an executing unit that executes a replication process of replicating the target data to the replication storage area, if the first or the second determining unit determines that the identifier of the requesting server is included.

2. The storage device according to claim 1, wherein
the first condition is that the servers are operable to access the target data, and
the second condition is that the servers have authority to replicate the target data to an arbitrary storage area.

3. The storage device according to claim 1, wherein
the first condition is that the servers that are operable to access the replication storage area;
of the second condition is that the servers that have authority to replicate arbitrary data to the replication storage area.

4. The storage device according to claim 1, further comprising:
a third determining unit that, if a replication request is accepted by the accepting unit, determines whether the identifier of the requesting server is included in a third table that stores identifiers of the servers that are operable to access the replication storage area; and
a fourth determining unit that, if a replication request is accepted by the accepting unit, determines whether the identifier of the requesting server is included in a fourth table that stores identifiers of the servers that have authority to replicate arbitrary data to the replication storage area, wherein
the executing unit executes the replication process, if the first or the second determining unit determines that the identifier of the requesting server is included and the third or the fourth determining unit determines that the identifier of the requesting server is included,
the first condition is that the servers are operable to access the target data, and
the second condition is that the servers have authority to replicate the target data to an arbitrary storage area.

5. The storage device according to claim 4, further comprising:
a first transmitter that transmits to another storage device that is directly connected to another server that is operable to access the target data and that is different from the requesting server, an authorization request that is from the requesting server and requests authority to replicate the target data to an arbitrary storage area;
a first receiver that receives from the other storage device, an authorization response that is from the other server and in response to the authorization request transmitted by the first transmitter; and
a first updating unit that updates the second table, based on the authorization response received by the first receiver.

6. The storage device according to claim 5, wherein
the first receiver receives from the other storage device directly connected to the other server, an authorization request that is from the other server different from a server directly connected to the storage device, the authorization request requesting authority to replicate to an arbitrary storage area, the target data accessible by the server, and
the first transmitter transmits to the other storage device, an authorization response that is from the server, in response to the authorization request received by the first receiver.

7. The storage device according to claim 4, further comprising:
a second transmitter that transmits to another storage device that is directly connected to another server that is operable to access the replication storage area and that is different from the requesting server, an authorization request that is from the requesting server and requests authority to replicate arbitrary data to the replication storage area;
a second receiver that receives from the other storage device, an authorization response that is from the other server and in response to the authorization request transmitted by the second transmitter; and
a second updating unit that updates the fourth table, based on the authorization response received by the second receiver.

8. The storage device according to claim 7, wherein
the second receiver receives from the other storage device directly connected to the other server, an authorization request that is from the other server different from a server directly connected to the storage device, the authorization request requesting authority to replicate arbitrary data to the replication storage area accessible by the server, and
the second transmitter transmits to the other storage device, an authorization response that is from the server, in response to the authorization request received by the second receiver.

9. The storage device according to claim 1, wherein
the first condition is that the servers that are operable to access the target data, and
the second condition is that the servers that are operable to access the replication storage area.

10. The storage device according to claim 1, wherein
the first condition is that the servers that have authority to replicate the target data to an arbitrary storage area, and
the second condition is that the servers that have authority to replicate arbitrary data to the replication storage area.

11. The storage device according to claim 1, wherein
the first condition is that the servers that are operable to access the target data, and
the second condition is that the servers that have authority to replicate arbitrary data to the replication storage area.

12. The storage device according to claim 1, wherein
the first condition is that the servers that have authority to replicate the target data to an arbitrary storage area, and
the second condition is that the servers that are operable to access the replication storage area.

13. A data replication method comprising:
accepting a replication request that concerns a replication storage area for target data and that is from a requesting server that is among a plurality of servers;
first determining, if a replication request is accepted at the accepting, whether an identifier of the requesting server is included in a first table that stores identifiers of the servers that are operable to access the target data;
determining, if a replication request is accepted at the accepting, whether the identifier of the requesting server is included in a second table that stores identifiers of the servers that have authority to replicate the target data to an arbitrary storage area; and
executing a replication process of replicating the target data to the replication storage area, if at the first or the second determining, the identifier of the requesting server is determined to be included.

14. A storage system comprising a plurality of servers and a storage device, wherein
the storage device comprises:
a accepting unit that accepts a replication request that concerns a replication storage area for target data and that is from a requesting server that is among the servers;
a first determining unit that, if a replication request is accepted by the accepting unit, determines whether an identifier of the requesting server is included in a first table that stores identifiers of the servers that are operable to access the target data;
a second determining unit that, if a replication request is accepted by the accepting unit, determines whether the identifier of the requesting server is included in a second table that stores identifiers of the servers that have authority to replicate the target data to an arbitrary storage area; and
an executing unit that executes a replication process of replicating the target data to the replication storage area, if the first or the second determining unit determines that the identifier of the requesting server is included.
